(19) United States
(12) Patent Application Publication
(10) Pub. No.: US 2012/0265592 A1
(43) Pub. Date: Oct. 18, 2012

(54) SYSTEM AND METHOD OF SATISFYING A SHARED ADVERTISING OBLIGATION

(76) Inventor: Marc Vianello, Prairie Village, KS (US)

(21) Appl. No.: 13/086,157

(22) Filed: Apr. 13, 2011

(51) Int. Cl. G06Q 30/00

(52) U.S. Cl. 705/14.17

(57) ABSTRACT

A system and method for at least partially satisfying an advertising obligation is provided where a voucher is conveyed or sold to a consumer, the voucher is redeemed with a vendor, and the vendor further redeems the used voucher with an organizer in exchange for credit towards an advertising obligation. Aspects of the system and method are carried out online, with or without an intermediary on behalf of the organizer.

### CROSS-REFERENCE TO RELATED APPLICATIONS

None.

### BACKGROUND OF THE INVENTION

Presently, many business arrangements include agreements requiring that one or more parties to the agreement make advertising and/or marketing contributions to another party for the purpose of promoting sales and services of which either of both parties to the agreement will be a beneficiary.

One example of such an arrangement involves a shopping center landlord and one or more tenants. It is not uncommon for a lease agreement to require that one or more tenants contribute to a joint advertising fund for the shopping center.

An agreement between a franchisor and a franchisee is also likely to include a provision whereby the franchisee is contractually obligated to contribute to an advertising fund and/or participate in a marketing plan required or maintained by the franchisor.

Additionally, contributions towards an advertising fund are often required in the case of company stores (Firestone or Pizza Hut) and for membership in some trade organizations.

Contributions by one or more parties to an advertising fund or marketing plan may be desirable to promote traffic to physical stores and/or to Internet websites.

The common economic circumstances of both parties to an agreement requiring contribution to a shared advertising/marketing fund make the effective expenditure of advertising and marketing funds and the most efficient satisfaction of marketing obligations mutually desirable.

### SUMMARY OF THE INVENTION

In accordance with one embodiment of the present inventive system and method, a computer implemented method is provided for satisfying at least a portion of an advertising contribution obligation owed to an organizer, including the steps of conveying a voucher to a consumer, accepting the voucher from the consumer as at least partial payment for a transaction between the consumer and a retailer, and accepting the voucher from the retailer as at least partial payment towards the advertising contribution obligation. According to another embodiment of the inventive method, the transaction between the retailer and the consumer is performed online. Further disclosed is a variation where the transaction between the retailer and the consumer is performed at a physical retail location. According to another variation of the inventive method, the step of selling a voucher to a consumer online is performed by an intermediary on behalf of the organizer. Also disclosed is where the step of selling a voucher to a consumer online further includes the step of associating a customer profile with the voucher. Further shown is where the step of accepting the voucher from the consumer further comprises reading the customer profile. According to yet another variation, the step of conveying a voucher to a consumer is carried out electronically. In another embodiment, the step of conveying a voucher to a consumer is carried out by physical delivery of the voucher. According to another embodiment of the inventive method, the step of reading the customer profile also associates a record of the consumer's purchase preferences with the customer profile.

In accordance with another embodiment of the present invention, provided is a computer readable medium having stored thereon, a set of instructions for performing a method of satisfying at least a portion of a shared advertising obligation owed by a vendor to an organizer, the method including the steps of selling a voucher to a consumer online, where at least a portion of the proceeds from the sale of the voucher are received by the organizer, receiving the voucher from the vendor where the voucher has been redeemed by the consumer in a transaction with the vendor, and providing the vendor with at least partial credit towards satisfaction of the shared advertising obligation, the credit being at least partially based on the redeemed voucher. Another embodiment of the inventive method features the step of validating the vouchers received from the vendor. Further still, a variation of the present invention is disclosed where the step of providing the vendor with at least partial credit is performed on a periodic basis. According to another aspect of the present inventive system and method, the step of receiving the voucher from the vendor is performed electronically. According to yet another aspect of the present inventive system and method, the transaction between the vendor and the consumer is performed online. Further according to still another embodiment of the inventive method, the step of selling a voucher to a consumer online is performed by an intermediary on behalf of the organizer.

In accordance with yet another embodiment of the present invention, provided is an organizer operated, computer readable medium having stored thereon, a set of instructions for performing a method of at least partially satisfying an advertising obligation owed by a vendor to an organizer, including the steps of selling a voucher to a consumer online, where proceeds from the sale of the voucher are received by the organizer and where the voucher is redeemable with the vendor, redeeming the voucher, accepting the voucher from the vendor where the voucher has been redeemed by the vendor in a sale transaction with the consumer, and providing the vendor with a credit amount towards satisfaction of the advertising obligation for the voucher. Another embodiment of the inventive method includes the step of delivering the voucher to the consumer electronically. Another aspect of the inventive method includes a computer readable medium where the step of redeeming the voucher further includes validating the voucher. Yet another embodiment of the inventive method includes the step of redeeming the voucher further includes validating the voucher and reporting the voucher as redeemed.

In accordance with still another embodiment of the present invention, a computer implemented method for satisfying an advertising obligation owed by a vendor to an organizer is provided which includes the steps of selling a voucher to a consumer online, where the voucher is redeemable with the vendor, validating the voucher at a vendor point of sale, reporting the voucher as redeemed, and crediting the vendor with a predefined amount towards satisfaction of the advertising obligation for each of the validated vouchers. Another aspect of the present inventive system and method includes the step of notifying the vendor of the amount credited towards the shared advertising obligation. Also provided is a variation in which the step of validating the voucher is performed by scanning the voucher with an electronic reader. Also shown according to an embodiment is where the step of validating the voucher is performed by scanning the voucher and electronically verifying the voucher against a list of valid vouchers. Further included is the step of reporting the voucher as redeemed includes the step of updating a list of valid vouchers. Additionally shown is where the step of selling a voucher to a consumer online further includes the step of associating a customer profile with the voucher. Further shown is an embodiment of a computer implemented method where the step of validating the voucher further includes the step of verifying the customer profile information associated with the voucher.

In another embodiment of the inventive method, the step of selling a voucher to a consumer online is performed by an intermediary. In yet another embodiment of the inventive method, the step of crediting the vendor is performed on a periodic basis. In still another embodiment of the inventive method, further includes the step of notifying the vendor of the amount credited towards the advertising obligation. In yet another embodiment of the inventive method, the step of validating the voucher is performed by scanning the voucher with an electronic reader. In still another embodiment of the inventive method, the step of validating the voucher is performed by scanning the voucher and electronically verifying the voucher against a list of valid vouchers. According to another embodiment of the inventive method, the step of validating the voucher is performed online by the consumer interacting with an Internet site. Further still, according to another embodiment of the inventive method, the step of reporting the voucher as redeemed includes the step of updating a list of valid vouchers. According to another embodiment of the inventive method, the step of selling a voucher to a consumer online further includes the step of associating a customer profile with the voucher. Additionally, according to another embodiment of the inventive method, the step of validating the voucher further includes the step of verifying the customer profile information associated with the voucher.

In accordance with still another embodiment of the present invention, a computer implemented method for raising funds to satisfy an advertising obligation owed to an organizer is provided where the method includes the steps of selling a voucher to a consumer in a transaction with an intermediary, where the organizer receives a portion of the proceeds from the sale of the voucher, redeeming the voucher as at least partial payment in a sales transaction between the consumer and a retailer, accepting the redeemed voucher from the retailer, and crediting the retailer by a predetermined amount towards satisfaction of the advertising obligation for the redeemed voucher. According to still another embodiment of the inventive method, the step of selling a voucher to a consumer is performed online. In yet another embodiment of the inventive method, the step of crediting the retailer is performed on a periodic basis. In still another embodiment of the inventive method, the organizer is one of the group consisting of: franchiser, landlord, school, property manager, trade group, company store, and any entity operating pursuant to Section 501 of the Internal Revenue Code of the United States of America.

In accordance with still another embodiment of the present invention, a computer readable medium is provided where the computer readable medium includes a stored set of instructions for performing a method of satisfying at least a portion of a shared advertising obligation owed by a vendor to an organizer, the method including the steps of selling a voucher to a consumer online, where the sale is by an intermediary on behalf of the organizer, receiving the voucher from the vendor where the voucher has been redeemed by the consumer in a transaction with the vendor, and providing the vendor with at least partial credit towards satisfaction of the shared advertising obligation, such credit being at least partially based on the redeemed voucher.

Another embodiment of the inventive method, further includes the step of validating the voucher received from the vendor. According to still another embodiment of the inventive method, the step of providing the vendor with at least partial credit is performed on a periodic basis. In an additional embodiment of the inventive method, the step of receiving the voucher from the vendor is performed electronically. In another embodiment of the inventive method, the transaction between the vendor and the consumer is performed online.

In accordance with still another embodiment of the present invention, an intermediary operated, computer readable medium is provided where the computer readable medium includes stored instructions for performing a method of at least partially satisfying an advertising obligation owed by a vendor to an organizer, the method including the steps of selling a voucher to a consumer online, where the voucher is redeemable with the vendor, redeeming the voucher by the vendor from the consumer in a sale transaction, accepting the voucher by the organizer from the vendor, and providing by the organizer to the vendor a credit towards satisfaction of the advertising obligation of the vendor to the organizer, where the credit is at least partially based on the redeemed voucher.

According to another embodiment of the inventive method, further includes the step of delivering the voucher to the consumer electronically. In yet another embodiment of the inventive method, the step of selling a voucher to a consumer online is performed by the organizer. In another embodiment of the inventive method, the step of selling a voucher to a consumer online is performed by the intermediary on behalf of the organizer. In still another embodiment of the inventive method, the step of redeeming the voucher further includes validating the voucher. According to yet another embodiment of the inventive method, the step of redeeming the voucher further includes validating the voucher and reporting the voucher as redeemed.

There has thus been outlined, rather broadly, certain embodiments of the invention in order that the detailed description herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE SEVERAL VIEWS OF THE DRAWING

Further features of the present invention will become apparent to those skilled in the art to which the present invention relates from reading the following description with reference to the accompanying drawings, in which:

FIG. 1 is an illustration of a distributed network according to one embodiment of the present invention.

FIG. 2 is a block diagram illustrating a method according to an embodiment of the present invention.

FIG. 3 is a block diagram illustrating a method according to another embodiment of the present invention.

FIG. 4 is an illustration of a voucher according to one embodiment of the present invention.

FIG. 5 is an alternate illustration of a voucher according to one embodiment of the present invention.

FIG. 6 is an illustration of a customer loyalty card, which may be used in accordance with another embodiment of the present invention and inventive method.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the Figures.

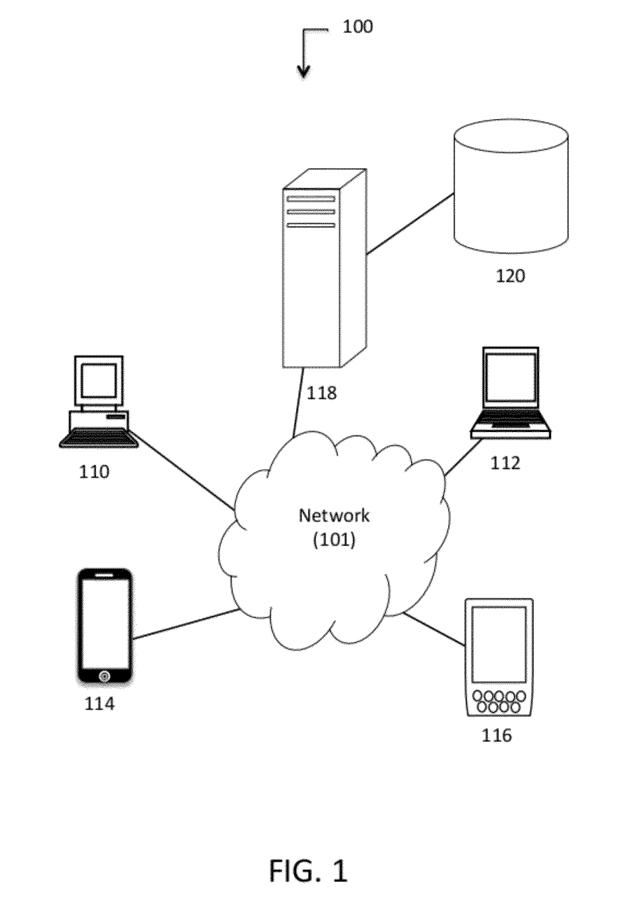

FIG. 1 provides an illustration of a distributed network 100 environment in which an embodiment of the present inventive system and method may be practiced. A distributed network 100 may be implemented as an intranet, a local area network (LAN), or a wide area network (WAN) such as the Internet, wireless networks, the public service telephone network (PSTN), or any other medium capable of transmitting or receiving digital information. The distributed network 100 contains a network 101. The network 101 is the medium used to provide communications links between network connected devices and may include switches, routers, hubs, wired connections, wireless communication links, or fiber optic cables. Devices connected to the network 101 may include a computer 110, portable notebook computer 112, smartphone 114, PDA (personal digital assistant) 116, and server 118 with a data repository 120. Devices connected to the network may also contain a processor and memory for data storage.

Those of ordinary skill in the art will appreciate that the hardware depicted in FIG. 1 may vary depending on the implementation of an embodiment present invention. For example, other devices, such as NAS (network attached storage) devices and the like, also may be used in addition to or in place of the hardware depicted. The depicted example is not meant to imply architectural limitations with respect to the present invention.

A “client” should be broadly construed to mean any device connected to a network, or any device used to request or get a information. The client includes a browser such as a web browser like Firefox, Internet Explorer, or Chrome. The client browser further includes XML compatibility and support for application plug-ins or helper applications. The term “server” should be broadly construed to mean a computer, computer platform, an adjunct to a computer or platform, or any component thereof used to send a document or a file to a client. One of skill in the art will appreciate that according to some embodiments of the present invention, server 118 may include various capabilities and provide functions including that of a web server, E-mail hosting, application hosting, and database hosting, some or all of which may be implemented in various ways, including as three separate processes running on multiple server computer systems, as processes or threads running on a single computer system, as processes running in virtual machines, and as multiple distributed processes running on multiple computer systems distributed throughout the network.

The term “computer” should be broadly construed to mean a programmable machine that receives input, stores and manipulates data, and provides output in a useful format. “PDA” and “Smartphone” should be broadly construed to include information appliances, tablet devices, handhelds and any programmable machine that receives input, stores and manipulates data, and provides output in a useful format such as an Android OS based device, Palm, Windows Mobile, an iPad, or iPhone both from Apple, Inc. Smartphones may include complete operating system software providing a platform for application developers and may include features such as a camera, infrared transceiver, RFID transceiver, or other multiple types of wireless functionality.

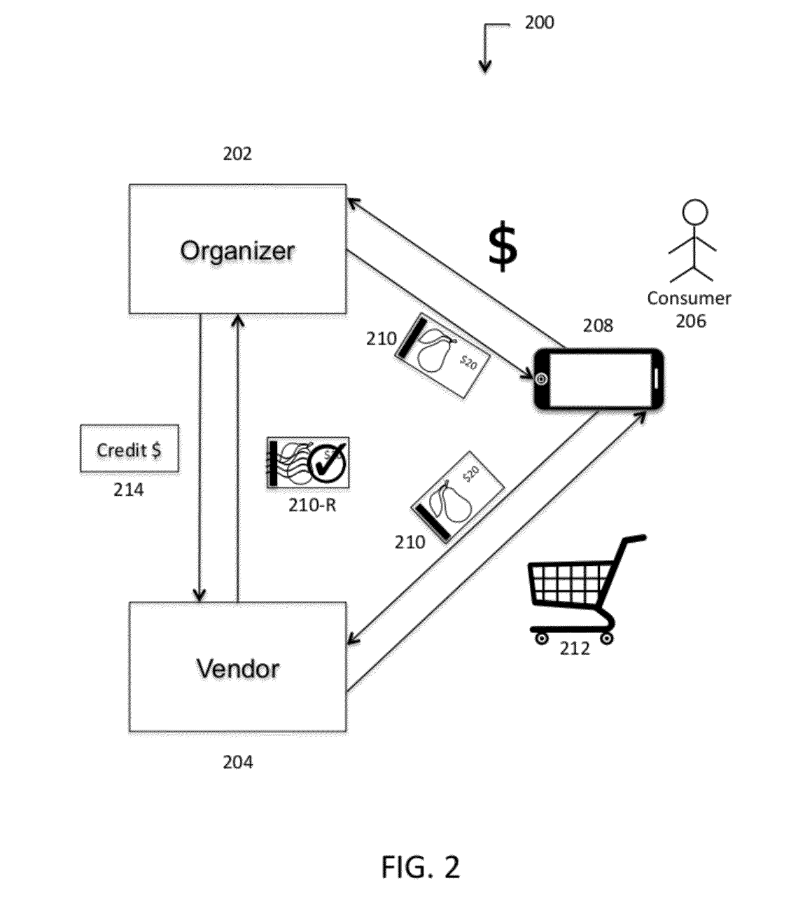

Turning to FIG. 2, 200 shows a block diagram illustrating a method according to one embodiment of the present invention. As shown, organizer 202, vendor 204, and consumer 206 are in communication over a distributed network as shown in FIG. 1. Vendor 204, by virtue of an agreement (preferably written), is obligated to contribute to a shared advertising fund to organizer 202. Organizer 202 conveys a voucher 210 to consumer 206 online. As shown, consumer 206 uses smartphone 208 to purchase the voucher 210 from the organizer 202. As shown, consumer 206 pays organizer 202 for the voucher 210 directly. Voucher 210 is redeemable by consumer 206 for use in a transaction with vendor 204 in exchange for goods and/or services 212. Vendor 204 turns the voucher 210-R (now redeemed) into organizer 202 in exchange for credit 214 towards vendor's 204 advertising fund contribution requirement.

According to some embodiments of the present inventive method, voucher 210 is conveyed to consumer 206 in electronic form, online. According to other embodiments of the inventive method, the voucher 210 is conveyed to the consumer 206 via a physical medium such as a printed coupon, advertisement, or handout. It will appreciated by one of skill in the art that according to some embodiments of the present inventive system and method, the organizer 202 conveys the voucher 210 to the consumer 206 at little or no cost to the consumer 206.

Advertising should be broadly construed to include marketing and promotion in general. Organizer 202 may include a landlord, shopping center management, franchisor, trade group, professional association, any entity operating pursuant to Section 501 of the Internal Revenue Code of the United States of America, and the like. Vendor 204 may include a tenant, retailer, service provider, professional or trade group member, student, contributor, or the like.

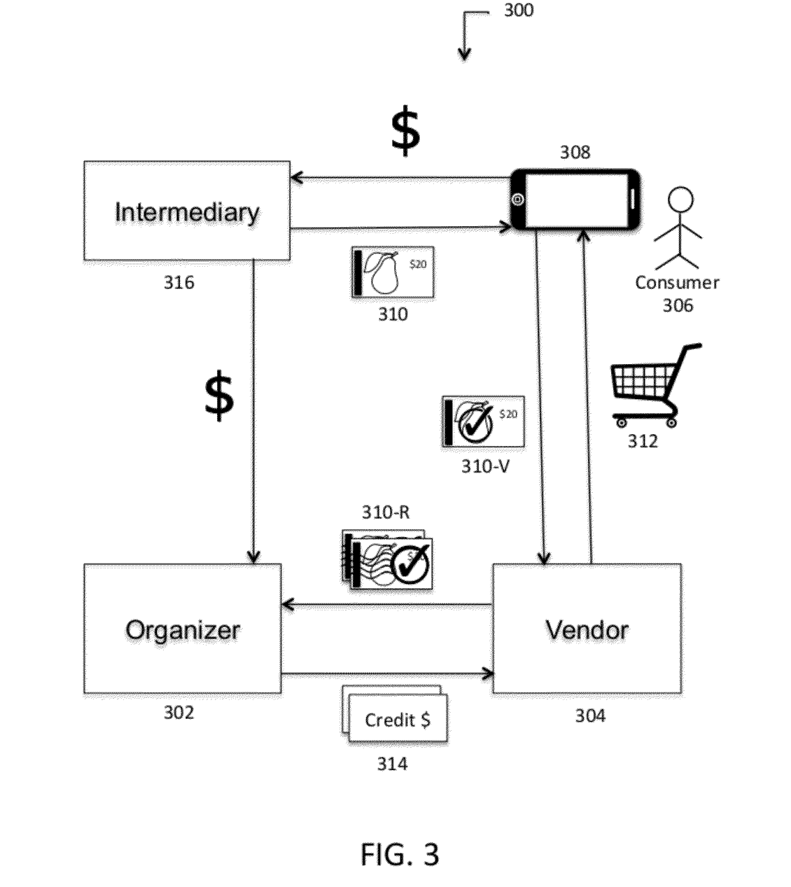

FIG. 3 is a block diagram 300 illustrating an alternate method according to another embodiment of the present invention. As shown, organizer 302, vendor 304, consumer 306, and intermediary 316 are in communication over a distributed network such as that shown in FIG. 1. Vendor 304, by virtue of an agreement (preferably written), is obligated to contribute to a shared advertising fund to organizer 302. Organizer 302, via intermediary 316, conveys a voucher 310 to consumer 306 online. As shown, consumer 306 uses smartphone 308 to purchase the voucher 310 from the intermediary 316. As shown, consumer 306 pays the intermediary 316 for the voucher 310 directly and intermediary 316 pays at least a portion of the proceeds from the sale of the voucher 310 to organizer 302.

One of skill in the art will appreciate that according to other embodiments of the inventive method, voucher 310 is conveyed to the consumer 306 via a physical medium such as a printed coupon, advertisement, or handout in addition to being conveyed to the consumer 306 electronically. It will further be appreciated by one of skill in the art that according to some embodiments of the inventive system and method, voucher 310 is conveyed to the consumer 306 at little or no cost to the consumer 306.

Voucher 310 is redeemable by consumer 306 for use in a transaction with vendor 304 in exchange for goods and/or services 312. According to some embodiments of the present inventive system and method, vendor 304 authenticates the voucher to confirm that it is valid. As shown, vendor 304 validates the voucher 310-V (now verified or validated) and accepts it as at least partial payment from the consumer 306 for goods and/or services 312. Vendor 304 turns the voucher 310-R (now redeemed) into organizer 302 in exchange for credit 314 towards vendor's 304 advertising fund contribution requirement.

The process of authentication/validation may be carried out by the vendor 304 using any number of known methods and may do so at a point of sale. Additionally, according to some embodiments of the inventive method, the organizer 302 validates each redeemed voucher independently of whether or not the vendor 304 validated the voucher 310, prior to the organizer 302 providing the vendor 304 with at least partial credit towards satisfaction of at least of a portion of the advertising obligation. According to another embodiment of the present inventive system and method, the step of authentication is accomplished by generating a series of unique voucher serial numbers that a Vendor can electronically or manually enter into its point of sale system when a voucher is presented to the Vendor to determine that said voucher has not been previously used. Either the organizer or the Vendor can generate the unique serial numbers.

Intermediary 316 should be broadly construed to include any media whereby a coupon or voucher (whether electronic or physical) is conveyed to a consumer. Such media includes both electronic and physical media, such as, without limitation, online advertising websites, sellers of online advertising, online discount websites, online newsletters, and physical newspapers and magazines advertisements, direct mail advertisements, and the like.

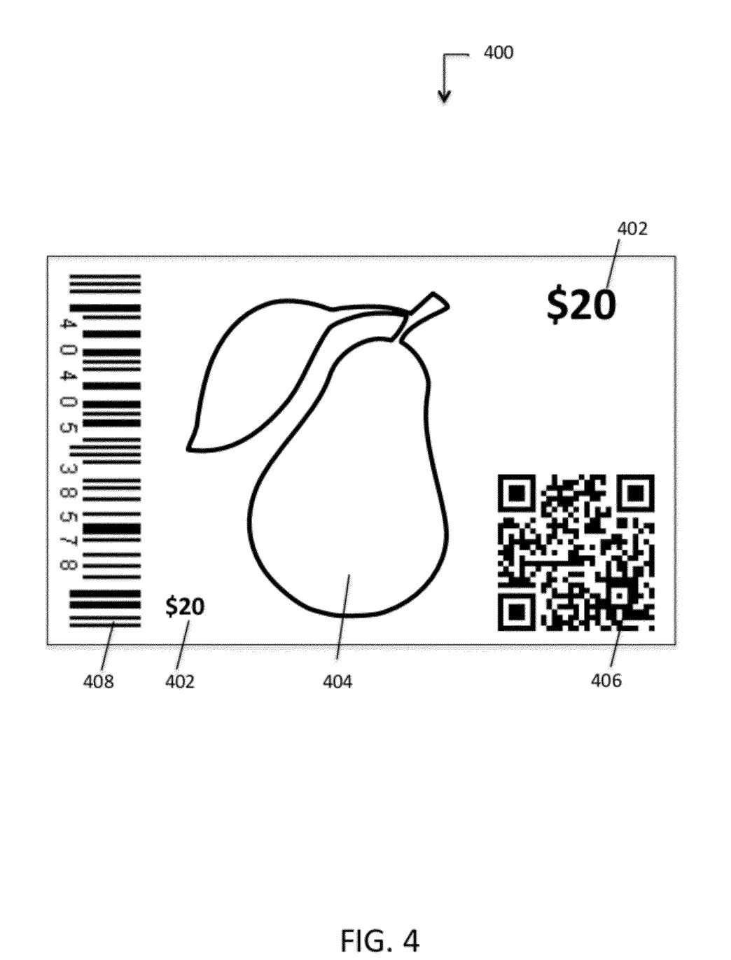

FIG. 4 is an illustration of a voucher 400 according to one embodiment of the present invention. As shown, voucher 400 is a printed item with a monetary value 402 displayed in one or more locations, a logo 404, a QR code 406 and a barcode 408. It will be appreciated by one of skill in the art that voucher as used herein should be broadly construed and analogous to a gift certificate, gift card, “mall bucks” and the like. As shown, voucher 400 includes both a QR code 406, and barcode 408, however, according to some embodiments of the present inventive method, voucher 400 may include either or both of these features. It will be further appreciated by one of skill in the art that in accordance with yet another embodiment of the present inventive system and method that voucher 400 may not include either QR code 406 or barcode 408.

It will be appreciated by one of skill in the art that any form of mobile tags, action codes and QR codes (for “Quick Response”), two-dimensional bar codes may be used in accordance with the present inventive system and method. An advantage of using such a code is that the voucher could be scanned and authenticated using a smartphone, camera phone, or connectable visual camera. According to some embodiments, other machine readable codes are used such as a magnetic stripe, smart chip, RFID, near field communications (NFC) or other machine readable code.

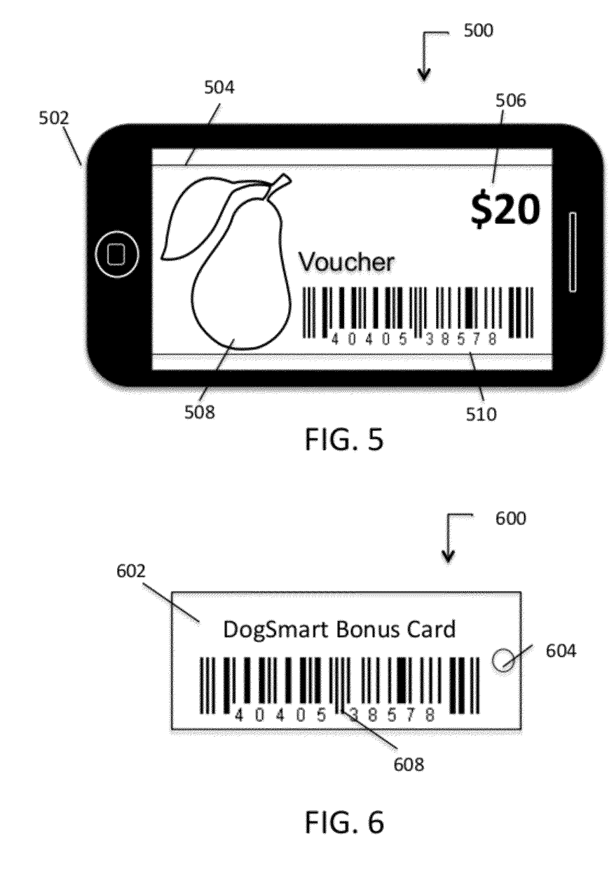

FIG. 5 is an alternate illustration of a voucher 500 displayed on smartphone 502 screen 504 according to one embodiment of the present invention. Voucher 500 includes a value 506, logo 508, and a barcode 510. As mentioned with respect to FIG. 4, one of skill in the art will appreciate that other machine readable codes or tags may be used. Additionally, according to some embodiments of the present inventive method, a combination of a visual machine readable code could be used in conjunction with a non visual code such as a Bluetooth crypto key, infrared code, near field communications code, wifi or the like for authentication purposes.

FIG. 6 is an illustration of a customer loyalty card 600 which may be used according to one embodiment of the present invention and inventive method. As depicted, customer loyalty card 600 includes the names of the issuer 602, a convenient keychain opening 604, and a barcode 608.

One of ordinary skill in the art will appreciate that processes in accordance with the teachings of the present invention are capable of being performed and distributed in the form of a computer readable medium of instructions and a variety of forms and that the present invention applies equally regardless of the particular type of signal bearing media actually used to carry out the distribution.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A computer implemented method for satisfying at least a portion of an advertising contribution obligation owed to an organizer, the method comprising the steps of:
conveying a voucher to a consumer;
accepting said voucher from said consumer as at least partial payment for a transaction between said consumer and a retailer; and
accepting said voucher from said retailer as at least partial payment towards the advertising contribution obligation.

2. The computer implemented method of claim 1 wherein the transaction between said retailer and said consumer is performed online.

3. The computer implemented method of claim 1 wherein the transaction between said retailer and said consumer is performed at a physical retail location.

4. The computer implemented method of claim 1 wherein the step of conveying a voucher to a consumer is carried out electronically.

5. The computer implemented method of claim 1 wherein the step of conveying a voucher to a consumer is carried out by physical delivery of said voucher.

6. The computer implemented method of claim 1 wherein the step of conveying a voucher to a consumer is performed by an intermediary.

7. The computer implemented method of claim 1 wherein the step of conveying a voucher to a consumer further includes the step of associating a customer profile with said voucher.

8. The computer implemented method of claim 7 wherein the step of accepting said voucher from said consumer further comprises reading said customer profile.

9. The computer implemented method of claim 8 wherein the step of reading said customer profile associates a record of said consumer's purchase preferences with said customer profile.

10. A computer readable medium having stored thereon, a set of instructions for performing a method of satisfying at least a portion of a shared advertising obligation owed by a vendor to an organizer, the method comprising the steps of:
selling a voucher to a consumer online, wherein at least a portion of the proceeds from the sale of said voucher are received by the organizer;
receiving said voucher from the vendor wherein said voucher has been redeemed by said consumer in a transaction with the vendor; and
providing the vendor with at least partial credit towards satisfaction of the shared advertising obligation, said credit being at least partially based on said redeemed voucher.

11. The computer readable medium of claim 10 further comprising the step of validating said voucher received from the vendor.

12. The computer readable medium of claim 10 wherein the step of providing the vendor with at least partial credit is performed on a periodic basis.

13. The computer readable medium of claim 10 wherein the step of receiving said voucher from the vendor is performed electronically.

14. The computer readable medium of claim 10 wherein said transaction between the vendor and said consumer is performed online.

15. The computer readable medium of claim 14 wherein the step of selling a voucher to a consumer online is performed by an intermediary on behalf of the organizer.

16. An organizer operated, computer readable medium having stored thereon, a set of instructions for performing a method of at least partially satisfying an advertising obligation owed by a vendor to an organizer, the method comprising the steps of:
selling a voucher to a consumer online, wherein proceeds from the sale of said voucher are received by the organizer and where said voucher is redeemable with the vendor;
redeeming said voucher;
accepting said voucher from the vendor wherein said voucher has been redeemed by said vendor in a sale transaction with the consumer; and
providing the vendor with a credit amount towards satisfaction of the advertising obligation for said voucher.

17. The computer readable medium of claim 16 further comprising the step of delivering said voucher to said consumer electronically.

18. The computer readable medium of claim 16 wherein the step of selling a voucher to a consumer online is performed by the organizer.

19. The computer readable medium of claim 16 wherein the step of selling a voucher to a consumer online is performed by an intermediary on behalf of the organizer.

20. The computer readable medium of claim 16 wherein the step of redeeming said voucher further includes validating said voucher.

21. The computer readable medium of claim 16 wherein the step of redeeming said voucher further includes validating said voucher and reporting said voucher as redeemed.

22. A computer implemented method for satisfying an advertising obligation owed by a vendor to an organizer, the method comprising the steps of:
selling a voucher to a consumer online, wherein said voucher is redeemable with the vendor;
validating said voucher at a vendor point of sale;
reporting said voucher as redeemed; and
crediting the vendor with a predefined amount towards satisfaction of the advertising obligation for each of said validated vouchers.

23. The computer implemented method of claim 22 further comprising the step of delivering said voucher to said consumer electronically.

24. The computer implemented method of claim 22 wherein the step of selling a voucher to a consumer online is performed by the organizer.

25. The computer implemented method of claim 22 wherein the step of selling a voucher to a consumer online is performed by an intermediary.

26. The computer implemented method of claim 22 wherein the step of crediting the vendor is performed on a periodic basis.

27. The computer implemented method of claim 22 further comprising the step of notifying the vendor of the amount credited towards the advertising obligation.

28. The computer implemented method of claim 22 wherein the step of validating said voucher is performed by scanning said voucher with an electronic reader.

29. The computer implemented method of claim 22 wherein the step of validating said voucher is performed by scanning said voucher and electronically verifying said voucher against a list of valid vouchers.

30. The computer implemented method of claim 22 wherein the step of validating said voucher is performed online by said consumer interacting with an Internet site.

31. The computer implemented method of claim 22 wherein the step of reporting said voucher as redeemed includes the step of updating a list of valid vouchers.

32. The computer implemented method of claim 22 wherein the step of selling a voucher to a consumer online further includes the step of associating a customer profile with said voucher.

33. The computer implemented method of claim 32 wherein the step of validating said voucher further includes the step of verifying said customer profile information associated with said voucher.

34. A computer implemented method for raising funds to satisfy an advertising obligation owed to an organizer, the method comprising the steps of:
selling a voucher to a consumer in a transaction with an intermediary, wherein the organizer receives a portion of the proceeds from the sale of said voucher;
redeeming said voucher as at least partial payment in a sales transaction between said consumer and a retailer;
accepting said redeemed voucher from said retailer; and
crediting said retailer by a predetermined amount towards satisfaction of the advertising obligation for said redeemed voucher.

35. The computer implemented method of claim 34 wherein the step of selling a voucher to a consumer is performed online.

36. The computer implemented method of claim 34 wherein the step of crediting said retailer is performed on a periodic basis.

37. The computer implemented method of claim 38 where the organizer is one of the group consisting of: franchiser, landlord, school, property manager, trade group, company store, and any entity operating pursuant to Section 501 of the Internal Revenue Code of the United States of America.

38. A computer readable medium having stored thereon, a set of instructions for performing a method of satisfying at least a portion of a shared advertising obligation owed by a vendor to an organizer, the method comprising the steps of:
selling a voucher to a consumer online, wherein said sale is by an intermediary on behalf of the organizer;
receiving said voucher from the vendor wherein said voucher has been redeemed by said consumer in a transaction with the vendor; and
providing the vendor with at least partial credit towards satisfaction of the shared advertising obligation, such credit being at least partially based on said redeemed voucher.

39. The computer readable medium of claim 38 further comprising the step of validating said voucher received from the vendor.

40. The computer readable medium of claim 38 wherein the step of providing the vendor with at least partial credit is performed on a periodic basis.

41. The computer readable medium of claim 38 wherein the step of receiving said voucher from the vendor is performed electronically.

42. The computer readable medium of claim 38 wherein said transaction between the vendor and said consumer is performed online.

43. An intermediary operated, computer readable medium having stored thereon, a set of instructions for performing a method of at least partially satisfying an advertising obligation owed by a vendor to an organizer, the method comprising the steps of:
selling a voucher to a consumer online, wherein said voucher is redeemable with the vendor;
redeeming said voucher by the vendor from the consumer in a sale transaction;
accepting said voucher by the organizer from the vendor; and
providing by the organizer to the vendor a credit towards satisfaction of the advertising obligation of the vendor to the organizer, wherein said credit is at least partially based on said redeemed voucher.

44. The computer readable medium of claim 43 further comprising the step of delivering said voucher to said consumer electronically.

45. The computer readable medium of claim 43 wherein the step of selling a voucher to a consumer online is performed by the organizer.

46. The computer readable medium of claim 43 wherein the step of selling a voucher to a consumer online is performed by the intermediary on behalf of the organizer.

47. The computer readable medium of claim 43 wherein the step of redeeming said voucher further includes validating said voucher.

48. The computer readable medium of claim 43 wherein the step of redeeming said voucher further includes validating said voucher and reporting said voucher as redeemed.
